(19) United States
(12) Patent Application Publication
(10) Pub. No.: US 2023/0083074 A1
(43) Pub. Date: Mar. 16, 2023

(54) PNEUMATIC TIRE

(71) Applicant: The Yokohama Rubber Co., LTD., Tokyo (JP)

(72) Inventor: Masahiro NARUSE, Kanagawa (JP)

(21) Appl. No.: 17/904,125

(22) PCT Filed: Feb. 12, 2021
(86) PCT No.: PCT/JP2021/005210

§ 371 Date: Aug. 12, 2022

(30) Foreign Application Priority Data
Feb. 17, 2020 (JP) 2020-024640
Feb. 17, 2020 (JP) 2020-024641

(51) Int. Cl. B60C 15/06; B60C 19/00

(52) U.S. Cl. CPC B60C 15/06; B60C 19/00; B60C 2019/004

(57) ABSTRACT

Provided is a pneumatic tire. A transponder is embedded on an outer side in a tire width direction of a carcass layer, and the tan δout (−20° C.) at −20° C. of a rubber member having the largest storage modulus at 20° C. of rubber members located on the outer side in the tire width direction of the transponder is in the range of from 0.1 to 0.7. Further, the transponder is embedded on the outer side in the tire width direction of the carcass layer, and the tan δin (−20° C.) at −20° C. of a rubber member having the largest storage modulus at 20° C. of rubber members located on an inner side in the tire width direction of the transponder is in the range of from 0.1 to 0.7.

### TECHNICAL FIELD

The present technology relates to a pneumatic tire embedded with a transponder and particularly relates to a pneumatic tire that can provide improved transponder communication performance and transponder durability while suppressing the degradation of the rolling resistance of the tire.

### BACKGROUND ART

For pneumatic tires, embedment of an RFID (radio frequency identification) tag (transponder) in a tire has been proposed (see, for example, Japan Unexamined Patent Publication No. H07-137510). In a case where a transponder is embedded in the tire and the heat build-up of a rubber member in a periphery of the transponder is low during travel in a low-temperature environment, the temperature of the rubber member does not rise, and the transponder may be damaged due to tire deformation. On the other hand, in a case where the heat build-up of the rubber member in the periphery of the transponder is too high, the rolling resistance of the tire degrades. Further, in a case where the transponder is disposed on an inner side in a tire width direction of a carcass layer, radio waves are blocked by a tire component (for example, a metal member such as a carcass or reinforcement made of steel) during communication with the transponder, and the communication performance of the transponder may degrade.

### SUMMARY

The present technology provides a pneumatic tire that can provide improved transponder communication performance and transponder durability while suppressing the degradation of the rolling resistance of the tire.

A pneumatic tire according to a first embodiment includes: a tread portion extending in a tire circumferential direction and having an annular shape; a pair of sidewall portions disposed on both sides of the tread portion; a pair of bead portions disposed on an inner side in a tire radial direction of the sidewall portions; and a carcass layer mounted between the pair of bead portions. The pneumatic tire is embedded with a transponder on an outer side in a tire width direction of the carcass layer. A tan δout (−20° C.) at −20° C. of a rubber member having a largest storage modulus at 20° C. of rubber members located on an outer side in the tire width direction of the transponder is in a range of from 0.1 to 0.7.

A pneumatic tire according to a second embodiment includes: a tread portion extending in a tire circumferential direction and having an annular shape; a pair of sidewall portions disposed on both sides of the tread portion; a pair of bead portions disposed on an inner side in a tire radial direction of the sidewall portions; and a carcass layer mounted between the pair of bead portions. The pneumatic tire is embedded with a transponder on an outer side in a tire width direction of the carcass layer. A tan δin (−20° C.) at −20° C. of a rubber member having a largest storage modulus at 20° C. of rubber members located on an inner side in the tire width direction of the transponder is in a range of from 0.1 to 0.7.

The first embodiment, which has the transponder embedded on the outer side in the tire width direction of the carcass layer, has no tire component that blocks radio waves during communication with the transponder, ensuring the communication performance of the transponder. The tan δout (−20° C.) at −20° C. of the rubber member having the largest storage modulus at 20° C. of the rubber members located on the outer side in the tire width direction of the transponder is in the range of from 0.1 to 0.7. Typically, in a low-temperature environment, the higher the tan δ of the rubber member, the higher the heat build-up, but the first embodiment sets the values of the tan δ of the rubber members located on the outer side in the tire width direction of the transponder in the range described above and can thereby maintain the heat build-up of the rubber members during travel in a low-temperature environment. Accordingly, the rubber members do not become brittle, and damage to the transponder due to tire deformation can be prevented. This can suppress the degradation of the rolling resistance of the tire and improve the durability of the transponder in a low-temperature environment.

The second embodiment, which has the transponder embedded on the outer side in the tire width direction of the carcass layer, has no tire component that blocks radio waves during communication with the transponder, ensuring the communication performance of the transponder. The tan δin (−20° C.) at −20° C. of the rubber member having the largest storage modulus at 20° C. of the rubber members located on the inner side in the tire width direction of the transponder is in the range of from 0.1 to 0.7. Typically, in a low-temperature environment, the higher the tan δ of the rubber member, the higher the heat build-up, but the second embodiment sets the values of the tan δ of the rubber members located on the inner side in the tire width direction of the transponder in the range described above and can thereby maintain the heat build-up of the rubber members during travel in a low-temperature environment. Accordingly, the rubber members do not become brittle, and damage to the transponder due to tire deformation can be prevented. This can suppress the degradation of the rolling resistance of the tire and improve the durability of the transponder in a low-temperature environment.

In the pneumatic tire according to the first embodiment, the tan δout (−20° C.) at −20° C. and a tan δout (0° C.) at 0° C. of the rubber member having the largest storage modulus at 20° C. of the rubber members located on the outer side in the tire width direction of the transponder preferably satisfy a relationship 0.5≤tan δout (0° C.)/tan δout (−20° C.)≤0.95. This can effectively improve the durability of the transponder while effectively suppressing the degradation of the rolling resistance of the tire.

Preferably, the transponder is covered with a covering layer, and a tan δc (−20° C.) at −20° C. of the covering layer and the tan δout (−20° C.) satisfy a relationship 0.3≤tan δc (−20° C.)/tan δout (−20° C.)≤0.9. This brings the tan δ of the covering layer and that of a rubber member adjacent to the covering layer closer together, can improve the heat retaining properties of the covering layer for the transponder, and thus can effectively improve the durability of the transponder.

In the pneumatic tire according to the second embodiment, the tan δin (−20° C.) at −20° C. and a tan δin (0° C.) at 0° C. of the rubber member having the largest storage modulus at 20° C. of the rubber members located on the inner side in the tire width direction of the transponder preferably satisfy a relationship 0.5≤tan δin (0° C.)/tan δin (−20° C.)≤0.95. This can effectively improve the durability of the transponder while effectively suppressing the degradation of the rolling resistance of the tire.

Preferably, the transponder is covered with a covering layer, and a tan δc (−20° C.) at −20° C. of the covering layer and the tan δin (−20° C.) satisfy a relationship 0.3≤tan δc (−20° C.)/tan δin (−20° C.)≤0.9. This brings the tan δ of the covering layer and that of a rubber member adjacent to the covering layer closer together, can improve the heat retaining properties of the covering layer for the transponder, and thus can effectively improve the durability of the transponder.

In the pneumatic tire according to the first or second embodiments, preferably, the transponder is covered with a covering layer, and a storage modulus E′c (−20° C.) at −20° C. of the covering layer is in a range of from 3 MPa to 17 MPa. This can improve the protective effect of the covering layer on the transponder, and effectively improve the durability of the transponder.

Preferably, the transponder is covered with a covering layer, and the covering layer has a relative dielectric constant of 7 or less. Accordingly, the transponder is protected by the covering layer, allowing the durability of the transponder to be improved and also ensuring radio wave transmissivity of the transponder to allow the communication performance of the transponder to be effectively improved.

Preferably, the transponder is covered with a covering layer, and the covering layer is formed of a rubber or an elastomer and 20 phr or more of a white filler. This enables the relative dielectric constant of the covering layer to be relatively small and effectively improve the communication performance of the transponder.

The white filler preferably includes from 20 phr to 55 phr of calcium carbonate. This enables the relative dielectric constant of the covering layer to be relatively small and effectively improve the communication performance of the transponder.

A center of the transponder is preferably disposed 10 mm or more away in the tire circumferential direction from a splice portion of a tire component. This can effectively improve the durability of the tire.

The transponder is preferably disposed between a position 15 mm away from and on an outer side in the tire radial direction of an upper end of a bead core of the bead portion and a tire maximum width position. Accordingly, the transponder is disposed in a region where the stress amplitude during travel is small, and this can effectively improve the durability of the transponder.

A distance between a cross-sectional center of the transponder and a tire outer surface is preferably 2 mm or more. This can effectively improve the durability of the tire as well as improve the scratch resistance of the tire.

Preferably, the transponder is covered with a covering layer, and the covering layer has a thickness of from 0.5 mm to 3.0 mm. This can effectively improve the communication performance of the transponder without making the tire outer surface uneven.

Preferably, the transponder includes an IC (integrated circuit) substrate that stores data and an antenna that transmits and receives data, and the antenna has a helical shape. This allows the transponder to follow deformation of the tire during travel, improving the durability of the transponder.

According to the first or second embodiment, the storage modulus E′ and the loss tangent tan δ are measured at a designated temperature, a frequency of 10 Hz, an initial strain of 10%, a dynamic strain of ±2% in a tensile deformation mode using a viscoelastic spectrometer in accordance with JIS (Japanese Industrial Standard)-K6394.

### BRIEF DESCRIPTION OF DRAWINGS

FIG. 1 is a meridian cross-sectional view illustrating a pneumatic tire according to an embodiment of the present technology.

FIG. 2 is a meridian cross-sectional view schematically illustrating the pneumatic tire of FIG. 1.

FIG. 3 is an equatorial cross-sectional view schematically illustrating the pneumatic tire of FIG. 1.

FIG. 4 is an enlarged cross-sectional view illustrating a transponder embedded in the pneumatic tire of FIG. 1.

FIGS. 5A and 5B are perspective views each illustrating a transponder that can be embedded in a pneumatic tire according to an embodiment of the present technology.

FIG. 6 is an explanatory diagram illustrating the position in a tire radial direction of a transponder in a test tire.

### DETAILED DESCRIPTION

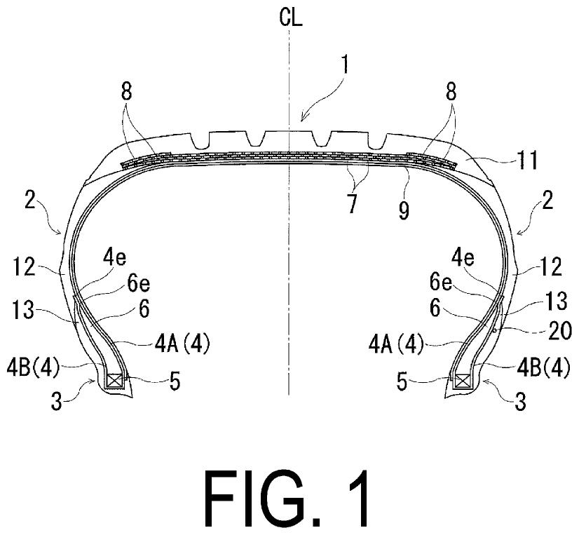

A configuration according to a first embodiment will be described in detail below with reference to the accompanying drawings. FIGS. 1 to 4 illustrate a pneumatic tire according to an embodiment of the present technology.

As illustrated in FIG. 1, the pneumatic tire according to the present embodiment includes a tread portion 1 extending in a tire circumferential direction and having an annular shape, a pair of sidewall portions 2 disposed on both sides of the tread portion 1, and a pair of bead portions 3 disposed on an inner side in a tire radial direction of the pair of sidewall portions 2.

At least one carcass layer 4 (one layer in FIG. 1) formed by arraying a plurality of carcass cords in a radial direction is mounted between the pair of bead portions 3. The carcass layer 4 is covered with rubber. The carcass cords forming the carcass layer 4 are preferably organic fiber cords of nylon, polyester, or the like. The bead portions 3 are each embedded with a bead core 5 having an annular shape, and a bead filler 6 made of a rubber composition and having a triangular cross-section is disposed on an outer circumference of the bead core 5.

On the other hand, a plurality of belt layers 7 (two layers in FIG. 1) are embedded on a tire outer circumferential side of the carcass layer 4 of the tread portion 1. The belt layers 7 include a plurality of reinforcing cords that are inclined with respect to the tire circumferential direction, and the reinforcing cords intersect each other between the layers. In the belt layers 7, the inclination angle of the reinforcing cords with respect to the tire circumferential direction is set in a range of, for example, from 10° to 40°. The reinforcing cords of the belt layers 7 are preferably steel cords.

To improve high-speed durability, at least one belt cover layer 8 (two layers in FIG. 1) formed by arraying reinforcing cords at an angle of, for example, 5° or less with respect to the tire circumferential direction is disposed on the tire outer circumferential side of the belt layers 7. In FIG. 1, the belt cover layer 8 located on the inner side in the tire radial direction forms a full cover that covers the entire width of the belt layers 7, and the belt cover layer 8 located on an outer side in the tire radial direction forms an edge cover layer that covers only end portions of the belt layers 7. The reinforcing cords of the belt cover layer 8 are preferably organic filament cords of nylon, aramid, or the like.

In the pneumatic tire described above, both ends 4e of the carcass layer 4 are each folded back from a tire inner side to a tire outer side around the bead core 5, wrapping around the bead core 5 and the bead filler 6. The carcass layer 4 includes: a body portion 4A corresponding to a portion extending from the tread portion 1 through each of the sidewall portions 2 to each of the bead portions 3; and a turned up portion 4B corresponding to a portion turned up around the bead core 5 at each of the bead portions 3 and extending toward a sidewall portion 2 side.

A tire inner surface includes an innerliner layer 9 disposed along the carcass layer 4. The tread portion 1 includes a cap tread rubber layer 11, the sidewall portion 2 includes a sidewall rubber layer 12, and the bead portion 3 includes a rim cushion rubber layer 13.

The pneumatic tire described above includes a transponder 20 embedded in a portion on an outer side in a tire width direction of the carcass layer 4. The transponder 20 extends along the tire circumferential direction. The transponder 20 may be inclined at an angle in a range of from −10° to 10° with respect to the tire circumferential direction.

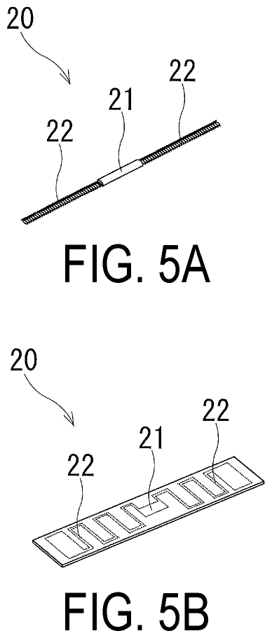

The transponder 20 may be, for example, a radio frequency identification (RFID) tag. As illustrated in FIGS. 5A and 5B, the transponder 20 includes an IC substrate 21 for storing data and an antenna 22 for transmitting and receiving data in a non-contact manner. The transponder 20 as described above can be used to write or read information related to the tire on a timely basis and to efficiently manage the tire. Note that “RFID” refers to an automatic recognition technology formed of a reader/writer including an antenna and a controller and of an ID (identification) tag including an IC substrate and an antenna, the automatic recognition technology allowing data to be communicated in a wireless manner.

The overall shape of the transponder 20 is not particularly limited, and can be, for example, a pillar-like shape or plate-like shape as illustrated in FIGS. 5A and 5B. In particular, the transponder 20 having a pillar-like shape as illustrated in FIG. 5A can follow deformation of the tire in various directions, and thus is suitable. In this case, the antenna 22 of the transponder 20 projects from each of both end portions of the IC substrate 21 and has a helical shape. This allows the transponder 20 to follow deformation of the tire during travel, improving the durability of the transponder 20. The length of the antenna 22 can be appropriately changed to ensure communication performance.

Further, in the pneumatic tire described above, of rubber members located on the outer side in the tire width direction of the transponder 20 (the sidewall rubber layer 12 and the rim cushion rubber layer 13 in FIG. 1), the rubber member having the largest storage modulus E′out (20° C.) at 20° C. (hereinafter sometimes referred to as an outer member) corresponds to the rim cushion rubber layer 13. The tan δout (−20° C.) at −20° C. of the outer member is in the range of from 0.1 to 0.7. The tan δout (−20° C.) is preferably in the range of from 0.2 to 0.5. The tan δout (−20° C.) at −20° C. of the outer member in a flex zone on the outer side in the tire radial direction of a vertex of the bead filler 6 can be set in the range of from 0.1 to 0.3. The storage modulus E′out (20° C.) at 20° C. of the outer member in a region on the inner side in the tire radial direction of the vertex of the bead filler 6 can be set in the range of from 8 MPa to 12 MPa. On the other hand, the storage modulus E′out (20° C.) at 20° C. of the outer member in the flex zone on the outer side in the tire radial direction of the vertex of the bead filler 6 can be set in the range of from 3 MPa to 5 MPa. Note that the rubber member (outer member) having the largest storage modulus at 20° C. does not include the covering layer 23 described below that covers the transponder 20.

Note that while the embodiment of FIG. 1 illustrates an example in which the transponder 20 is disposed between the turned up portion 4B of the carcass layer 4 and the rim cushion rubber layer 13, no such limitation is intended. The transponder 20 can also be disposed between the body portion 4A of the carcass layer 4 and the sidewall rubber layer 12. The outer member varies depending on the position where the transponder 20 is disposed, but in any case, the tan δout (−20° C.) at −20° C. of the outer member is set in the range described above.

The pneumatic tire described above, which has the transponder 20 embedded on the outer side in the tire width direction of the carcass layer 4, has no tire component that blocks radio waves during communication with the transponder 20, ensuring the communication performance of the transponder 20. Further, the tan δout (−20° C.) at −20° C. of the rubber member having the largest storage modulus E′out (20° C.) at 20° C. of the rubber members located on the outer side in the tire width direction of the transponder 20 is in the range of from 0.1 to 0.7, and thus the heat build-up of the rubber member can be maintained appropriately during travel in a low-temperature environment. Accordingly, the rubber member does not become brittle, and damage to the transponder 20 due to tire deformation can be prevented. This can suppress the degradation of the rolling resistance of the tire and improve the durability of the transponder 20 in a low-temperature environment.

Here, in a case where the value of the tan δout (−20° C.) is smaller than the lower limit value, the durability of the transponder tends to degrade due to tire deformation during travel, whereas in a case where the value of the tan δout (−20° C.) is larger than the upper limit value, the rolling resistance of the tire tends to degrade.

Note that of rubber members located on an inner side in the tire width direction of the transponder 20 (a coating rubber of the carcass layer 4, the bead filler 6, and the innerliner layer 9 in FIG. 1), the rubber member having the largest storage modulus E′ in (20° C.) at 20° C. (inner member) corresponds to the bead filler 6. To better protect the transponder 20 against tire deformation during travel, the tan δin (−20° C.) of the inner member and the tan δout (−20° C.) of the outer member preferably satisfy the relationship 0.2≤tan δin (−20° C.)/tan δout (−20° C.)≤3.0. In particular, in a case where the JIS hardness (20° C.) of the inner member is relatively high, the relationship 0.2≤tan δin (−20° C.)/tan δout (−20° C.)≤1.5 is preferably satisfied, and the relationship 0.6≤tan δin (−20° C.)/tan δout (−20° C.)≤1.3 is more preferably satisfied. In this case, stress concentration is unlikely to occur, and the durability of the tire is effectively improved. In a case where the JIS hardness (20° C.) of the inner member is relatively low, the relationship 0.8≤tan δin (−20° C.)/tan δout (−20° C.)≤3.0 is preferably satisfied, and the relationship 1.3≤tan δin (−20° C.)/tan δout (−20° C.)≤2.6 is more preferably satisfied. In this case, the cushioning effect on the transponder 20 in a low-temperature environment increases, and damage to the transponder 20 can be effectively prevented. Note that the rubber member having the largest storage modulus at 20° C. (inner member) does not include the covering layer 23 described below that covers the transponder 20.

In the pneumatic tire described above, the tan δout (−20° C.) at −20° C. and a tan δout (0° C.) at 0° C. of the outer member preferably satisfy the relationship 0.5≤tan δout (0° C.)/tan δout (−20° C.)≤0.95. The tan δ of the outer member at each temperature thus satisfying the relationship formula described above allows for effectively improving the durability of the transponder 20 while effectively suppressing the degradation of the rolling resistance of the tire. Here, in a case where the value of tan δout (0° C.)/tan δout (−20° C.) is smaller than the lower limit value, the heat build-up of the outer member decreases, the heat insulating effect thereof on the transponder 20 decreases, and the durability of the transponder 20 tends to degrade. Conversely, in a case where the value of tan δout (0° C.)/tan δout (−20° C.) is larger than the upper limit value, there is little temperature dependence of the tan δ of the outer member, and the rolling resistance of the tire slightly degrades.

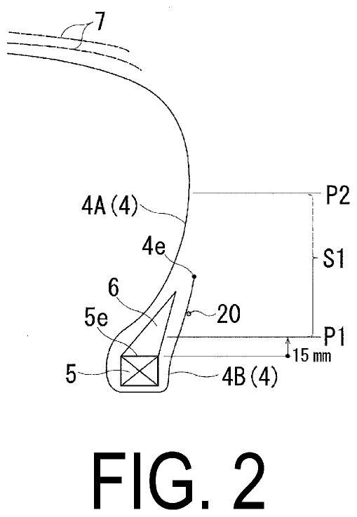

Further, the transponder 20 is preferably disposed in a placement region in the tire radial direction between a position P1 15 mm away from and on the outer side in the tire radial direction of an upper end 5e (an end portion on the outer side in the tire radial direction) of the bead core 5 and a position P2 where the tire width is greatest. That is, the transponder 20 is preferably disposed in a region S1 illustrated in FIG. 2. The transponder 20 disposed in the region S1 is positioned in a region where the stress amplitude during travel is small, and this can effectively improve the durability of the transponder 20, and does not degrade the durability of the tire. Here, the transponder 20 disposed on the inner side in the tire radial direction of the position P1 is too close to a metal member such as the bead core 5, and this tends to degrade the communication performance of the transponder 20. On the other hand, the transponder 20 disposed on the outer side in the tire radial direction of the position P2 is positioned in a region where the stress amplitude during travel is large, and damage to the transponder 20 itself and interfacial failure in a periphery of the transponder 20 are likely to occur, and this is not preferable.

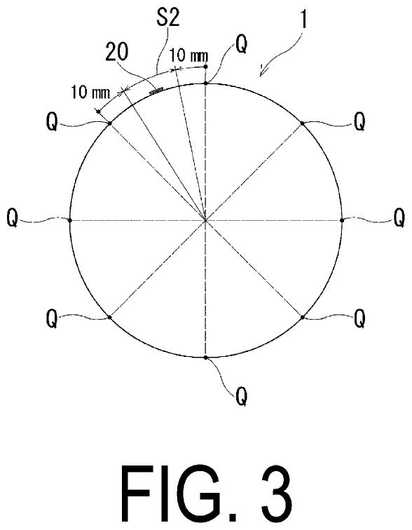

As illustrated in FIG. 3, a plurality of splice portions formed by overlaying end portions of tire components are on a tire circumference. FIG. 3 illustrates positions Q in the tire circumferential direction of the splice portions. The center of the transponder 20 is preferably disposed 10 mm or more away in the tire circumferential direction away from the splice portion of the tire component. That is, the transponder 20 is preferably disposed in a region S2 illustrated in FIG. 3. Specifically, the IC substrate 21 forming the transponder 20 is preferably located 10 mm or more away in the tire circumferential direction from the position Q. More preferably, all of the transponder 20 including the antenna 22 is located 10 mm or more away in the tire circumferential direction from the position Q, and most preferably, all of the transponder 20 covered with a covering rubber is located 10 mm or more away in the tire circumferential direction from the position Q. Also, the tire component disposed away from the transponder 20 is preferably the sidewall rubber layer 12, the rim cushion rubber layer 13, or the carcass layer 4, which is disposed adjacent to the transponder 20. By thus disposing the transponder 20 away from the splice portion of the tire component, the durability of the tire can be effectively improved.

Note that while the embodiment of FIG. 3 illustrates an example in which the positions Q in the tire circumferential direction of the splice portions of the tire components are disposed at equal intervals, no such limitation is intended. The positions Q in the tire circumferential direction can be set anywhere, and in either case, the transponder 20 is disposed 10 mm or more away in the tire circumferential direction from the splice portions of the tire components.

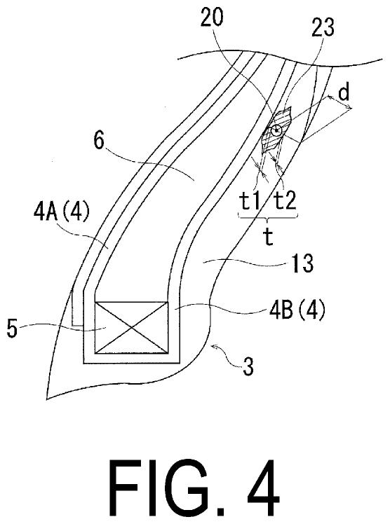

As illustrated in FIG. 4, a distance d between the cross-sectional center of the transponder 20 and the tire outer surface is preferably 2 mm or more. By thus spacing the transponder 20 and the tire outer surface apart from each other, the durability of the tire can be effectively improved, and the scratch resistance of the tire can be improved.

Further, the transponder 20 is preferably covered with the covering layer 23. The covering layer 23 covers the transponder 20 completely so as to sandwich both front and rear surfaces of the transponder 20. The covering layer 23 may be formed from a rubber having physical properties identical to those of a rubber forming the sidewall rubber layer 12 or the rim cushion rubber layer 13, or may be formed from a rubber having different physical properties. With the transponder 20 protected by the covering layer 23, the durability of the transponder 20 can be improved.

The covering layer 23 covering the transponder 20 is described in detail below. Physical properties of the covering layer 23 are preferably set such that the tan δc (−20° C.) at −20° C. of the covering layer 23 and the tan δout (−20° C.) of the outer member satisfy the relationship 0.3≤tan δc (−20° C.)/tan δout (−20° C.)≤0.9. By thus setting the physical properties of the covering layer 23 with regard to the outer member, the tan δ of the covering layer 23 and that of a rubber member adjacent to the covering layer 23 (for example, the rim cushion rubber layer 13) are brought closer together, the heat retaining properties of the covering layer 23 for the transponder 20 can be improved, and thus the durability of the transponder 20 can be effectively improved.

Further, the storage modulus E′c (−20° C.) at −20° C. of the covering layer 23 is preferably in the range of from 3 MPa to 17 MP a. By thus setting the physical properties of the covering layer 23, the protective effect of the covering layer 23 on the transponder 20 can be improved, and effectively improve the durability of the transponder 20. Here, in a case where the storage modulus E′c at −20° C. of the covering layer 23 is smaller than the lower limit value of the range described above, the rigidity of the covering layer 23 decreases, making the protective effect thereof on the transponder 20 tend to decrease, whereas in a case where the storage modulus E′c at −20° C. of the covering layer 23 is larger than the upper limit value of the range described above, the rigidity of the covering layer 23 increases, the covering layer 23 becomes brittle, and the covering layer 23 becomes prone to breakage, and thus the transponder 20 may be damaged.

The composition of the covering layer 23 is preferably a rubber or an elastomer and 20 phr or more of a white filler. Such a composition of the covering layer 23 can lower the relative dielectric constant of the covering layer 23, compared to a composition containing carbon, and effectively improve the communication performance of the transponder 20. Note that “phr” means weight parts per 100 parts by weight of a rubber component (elastomer).

The white filler forming the covering layer 23 preferably includes from 20 phr to 55 phr of calcium carbonate. This can lower the relative dielectric constant of the covering layer 23 and effectively improve the communication performance of the transponder 20. However, too much calcium carbonate in the white filler makes the covering layer 23 brittle and lowers its strength, and this is not preferable. The covering layer 23 can optionally include 20 phr or less of a silica (white filler) or 5 phr or less of a carbon black in addition to calcium carbonate. An addition of a small amount of silica and carbon black can lower the relative dielectric constant of the covering layer 23 while ensuring the strength thereof.

The covering layer 23 preferably has a relative dielectric constant of 7 or less, and more preferably of from 2 to 5. By thus setting the relative dielectric constant of the covering layer 23 as appropriate, the radio wave transmissivity of the transponder 20 during emission of radio waves can be ensured, and the communication performance of the transponder 20 can be effectively improved. Note that the rubber forming the covering layer 23 has a relative dielectric constant of from 860 MHz to 960 MHz at ambient temperature. Here, the ambient temperature is 23±2° C. and 60%±5% RH in accordance with the standard conditions of the JIS standard. The relative dielectric constant of the rubber is measured in accordance with an electrostatic capacitance method after a 24-hour treatment at 23° C. and 60% RH. The range from 860 MHz to 960 MHz described above corresponds to allocated frequencies of the RFID in a current UHF (ultra high frequency) band, but in a case where the allocated frequencies change, it is only required that the relative dielectric constant in the range of the allocated frequencies be specified as described above.

A thickness t of the covering layer 23 is preferably from 0.5 mm to 3.0 mm, and more preferably from 1.0 mm to 2.5 mm. Here, a thickness t of the covering layer 23 is a rubber thickness at a position including the transponder 20, and is, for example, a rubber thickness obtained by summing a thickness t1 and a thickness t2 on a straight line extending through the center of the transponder 20 and orthogonally to a tire outer surface, as illustrated in FIG. 4. Properly setting the thickness t of the covering layer 23 as described above allows the communication performance of the transponder 20 to be effectively improved without making the tire outer surface uneven. Here, the thickness t of the covering layer 23 being less than 0.5 mm fails to obtain the effect of improving the communication performance of the transponder 20. In contrast, the thickness t of the covering layer 23 exceeding 3.0 mm makes the tire outer surface uneven, and this is not preferable for appearance. Note that the cross-sectional shape of the covering layer 23 is not particularly limited and can be, for example, a triangular shape, a rectangular shape, a trapezoidal shape, or a spindle shape. The cross-sectional shape of the covering layer 23 of FIG. 4 is substantially spindle-shaped.

While the embodiment described above illustrates an example in which the end 4e of the turned up portion 4B of the carcass layer 4 is disposed at or near an upper end 6e of the bead filler 6, no such limitation is intended, and the end 4e of the turned up portion 4B of the carcass layer 4 can be disposed at any height. For example, the end 4e of the turned up portion 4B of the carcass layer 4 may be disposed on a side of the bead core 5. In such a low turn-up structure, the transponder 20 can be disposed between the bead filler 6 and the sidewall rubber layer 12 or the rim cushion rubber layer 13. Here, the rubber member adjacent on the outer side in the tire width direction of the covering layer 23 is the sidewall rubber layer 12 or the rim cushion rubber layer 13.

Next, a configuration according to a second embodiment will be described. A pneumatic tire according to the second embodiment, as with the first embodiment, has a tire structure as illustrated in FIGS. 1 to 5B.

In the pneumatic tire according to a second embodiment, of rubber members located on the inner side in the tire width direction of the transponder 20 (a coating rubber of the carcass layer 4, the bead filler 6, and the innerliner layer 9 in FIG. 1), the rubber member having the largest storage modulus E′ in (20° C.) at 20° C. (hereinafter sometimes referred to as an inner member) corresponds to the bead filler 6. The tan δin (−20° C.) at −20° C. of the inner member is in the range of from 0.1 to 0.7. The tan δin (−20° C.) is preferably in the range of from 0.2 to 0.4. The tan δin (−20° C.) at −20° C. of the inner member in a flex zone on the outer side in the tire radial direction of a vertex of the bead filler 6 can be set in the range of from 0.1 to 0.6. The storage modulus E′in (20° C.) at 20° C. of the inner member in a region on the inner side in the tire radial direction of the vertex of the bead filler 6 can be set in the range of from 8 MPa to 110 MPa. On the other hand, the storage modulus E′ in (20° C.) at 20° C. of the inner member in the flex zone on the outer side in the tire radial direction of the vertex of the bead filler 6 can be set in the range of from 5 MPa to 7 MPa. Note that the rubber member (inner member) having the largest storage modulus at 20° C. does not include the covering layer 23 described below that covers the transponder 20.

Note that while the embodiment of FIG. 1 illustrates an example in which the transponder 20 is disposed between the turned up portion 4B of the carcass layer 4 and the rim cushion rubber layer 13, no such limitation is intended. The transponder 20 can also be disposed between the body portion 4A of the carcass layer 4 and the sidewall rubber layer 12. The inner member varies depending on the position where the transponder 20 is disposed, but in any case, the tan δin (−20° C.) at −20° C. of the inner member is set in the range described above.

The pneumatic tire described above, which has the transponder 20 embedded on the outer side in the tire width direction of the carcass layer 4, has no tire component that blocks radio waves during communication with the transponder 20, ensuring the communication performance of the transponder 20. Further, the tan δin (−20° C.) at −20° C. of the rubber member having the largest storage modulus E′in (20° C.) at 20° C. of the rubber members located on the inner side in the tire width direction of the transponder 20 is in the range of from 0.1 to 0.7, and thus the heat build-up of the rubber member can be maintained appropriately during travel in a low-temperature environment. Accordingly, the rubber member does not become brittle, and damage to the transponder 20 due to tire deformation can be prevented. This can suppress the degradation of the rolling resistance of the tire and improve the durability of the transponder 20 in a low-temperature environment.

Here, in a case where the value of the tan δin (−20° C.) is smaller than the lower limit value, the durability of the transponder tends to degrade due to tire deformation during travel, whereas in a case where the value of the tan δin (−20° C.) is larger than the upper limit value, the rolling resistance of the tire tends to degrade.

Note that of rubber members located on the outer side in the tire width direction of the transponder 20 (the sidewall rubber layer 12 and the rim cushion rubber layer 13 in FIG. 1), the rubber member having the largest storage modulus E′out (20° C.) at 20° C. (outer member) corresponds to the rim cushion rubber layer 13. To better protect the transponder 20 against tire deformation during travel, the tan δout (−20° C.) of the outer member and the tan δin (−20° C.) of the inner member preferably satisfy the relationship 0.2≤tan δn (−20° C.)/tan δout (−20° C.)≤3.0. In particular, in a case where the JIS hardness (20° C.) of the inner member is relatively high, the relationship 0.2≤tan δin (−20° C.)/tan δout (−20° C.)≤1.5 is preferably satisfied, and the relationship 0.6≤tan δin (−20° C.)/tan δout (−20° C.)≤1.3 is more preferably satisfied. In this case, stress concentration is unlikely to occur, and the durability of the tire is effectively improved. In a case where the JIS hardness (20° C.) of the inner member is relatively low, the relationship 0.8≤tan δin (−20° C.)/tan δout (−20° C.)≤3.0 is preferably satisfied, and the relationship 1.3≤tan δin (−20° C.)/tan δout (−20° C.)≤2.6 is more preferably satisfied. In this case, the cushioning effect on the transponder 20 in a low-temperature environment increases, and damage to the transponder 20 can be effectively prevented. Note that the rubber member having the largest storage modulus at 20° C. (outer member) does not include the covering layer 23 described below that covers the transponder 20.

In the pneumatic tire described above, the tan δin (−20° C.) at −20° C. and a tan in (0° C.) at 0° C. of the inner member preferably satisfy the relationship 0.5≤tan δin (0° C.)/tan δin (−20° C.)≤0.95. The tan δ of the inner member at each temperature thus satisfying the relationship formula described above allows for effectively improving the durability of the transponder 20 while effectively suppressing the degradation of the rolling resistance of the tire. Here, in a case where the value of tan δin (0° C.)/tan δin (−20° C.) is smaller than the lower limit value, the heat build-up of the inner member decreases, the heat insulating effect thereof on the transponder 20 decreases, and the durability of the transponder 20 tends to degrade. Conversely, in a case where the value of tan in (0° C.)/tan δin (−20° C.) is larger than the upper limit value, there is little temperature dependence of the tan δ of the inner member, and the rolling resistance of the tire slightly degrades.

Physical properties of the covering layer 23 covering the transponder 20 in the pneumatic tire described above are preferably set such that the tan δc (−20° C.) at −20° C. of the covering layer 23 and the tan δin (−20° C.) of the inner member satisfy the relationship 0.3≤tan δc (−20° C.)/tan δin (−20° C.)≤0.9. By thus setting the physical properties of the covering layer 23 with regard to the inner member, the tan δ of the covering layer 23 and that of a rubber member adjacent to the covering layer 23 (for example, the rim cushion rubber layer 13) are brought closer together, the heat retaining properties of the covering layer 23 for the transponder 20 can be improved, and thus the durability of the transponder 20 can be effectively improved.

### EXAMPLES

Tires of Comparative Examples 1 to 3 and Examples 1 to 16 were manufactured. The tires were each a pneumatic tire having a tire size of 265/40ZR20 and including: a tread portion extending in a tire circumferential direction and having an annular shape; a pair of sidewall portions disposed on both sides of the tread portion; a pair of bead portions disposed on an inner side in a tire radial direction of the sidewall portions; and a carcass layer mounted between the pair of bead portions, the pneumatic tire being embedded with a transponder. The position in a tire width direction of the transponder, the position in the tire radial direction of the transponder, the tan δout (−20° C.) of an outer member, tan δout (0° C.)/tan δout (−20° C.), the presence of a covering layer, the relative dielectric constant of the covering layer, the thickness of the covering layer, the tan δc (−20° C.) of the covering layer, the storage modulus E′c (−20° C.) of the covering layer, and tan δc (−20° C.)/tan δout (−20° C.) were set as in Table 1 and Table 2.

Comparative Examples 1 to 3 and Examples 1 to 16 used a transponder having a columnar shape, and set the distance in the tire circumferential direction from the center of the transponder to a splice portion of a tire component to 10 mm and the distance from a cross-sectional center of the transponder to a tire outer surface to 2 mm or more.

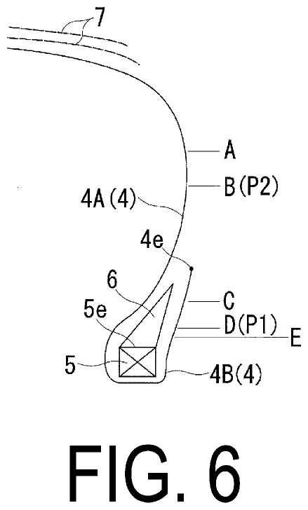

In Table 1 and Table 2, the position in the tire width direction of the transponder being “inner side” means that the transponder is disposed on an inner side in the tire width direction of the carcass layer, whereas the position in the tire width direction of the transponder being “outer side” means that the transponder is disposed on an outer side in the tire width direction of the carcass layer. In Table 1 and Table 2, the position in the tire radial direction of the transponder corresponds to one of positions A to E illustrated in FIG. 6.

In Comparative Examples 2 and 3 and Examples 1 to 16, the outer member is a rim cushion rubber layer. That is, in Table 1 and Table 2, “tan δout (0° C.)/tan δout (−20° C.)” is a ratio of the tan δ of the rim cushion rubber layer, which is the outer member. Further, “tan δc (−20° C.)/tan δout (−20° C.)” is a ratio of the tan δ of the covering layer with respect to the tan δ of the rim cushion rubber layer, which is the outer member. For the sake of convenience, Comparative Example 1 indicates physical properties of the rim cushion rubber layer as those of the outer member.

The test tires were subjected to tire evaluation (durability and rolling resistance) and transponder evaluation (communication performance and durability) in accordance with a test method described below, and the results are indicated together in Table 1 and Table 2.

### Durability (Tire and Transponder):

With each test tire mounted on a wheel of a standard rim, a travel test was performed using a drum testing machine at a temperature of −20° C., an air pressure of 120 kPa, 102% of the maximum load, and a travel speed of 81 km/h, and the distance traveled at the time of a tire failure was measured. Evaluation results are expressed as index values with Comparative Example 2 being assigned an index value of 100. Larger index values indicate superior tire durability. Further, each test tire was checked after the end of traveling for whether the transponder was communicable and whether the same was damaged. The results are indicated in three levels: “Excellent” in a case where the transponder was communicable and not damaged; “Good” in a case where the transponder was communicable but damaged; and “Poor” in a case where the transponder was not communicable.

### Rolling Resistance (Tire):

With each test tire mounted on a wheel of a standard rim, a travel test was performed using a drum testing machine at a speed of 80 km/h and a temperature of −20° C. in accordance with ISO (International Organization for Standardization) 28580, and the rolling resistance was measured. Evaluation results are expressed as index values using reciprocals of measurement values with Comparative Example 2 being assigned an index value of 100. Larger index values indicate lower rolling resistance and superiority.

### Communication Performance (Transponder):

For each test tire, a communication operation with the transponder was performed using a reader/writer. Specifically, the maximum communication distance was measured with the reader/writer set at a power output of 250 mW and a carrier frequency of from 860 MHz to 960 MHz. Evaluation results are expressed as index values with Comparative Example 2 being assigned an index value of 100. Larger index values indicate superior communication performance.

TABLE 1-1

| | | Comparative | Comparative | Comparative | | |
|---|---|---|---|---|---|---|
| | | Example 1 | Example 2 | Example 3 | Example 1 | Example 2 |
| Position in tire width | | Inner side | Outer side | Outer side | Outer side | Outer side |
| direction of transponder | | | | | | |
| Position in tire radial | | C | C | C | C | E |
| direction of transponder | | | | | | |
| Tan δout (−20° C.) of outer | | 0.30 | 0.05 | 0.80 | 0.30 | 0.30 |
| member | | | | | | |
| Tan δout(0° C.)/tan δout | | 0.7 | 0.7 | 0.7 | 0.7 | 0.7 |
| (−20° C.) | | | | | | |
| Presence of covering layer | | No | No | No | No | No |
| Relative dielectric constant of | | — | — | — | — | — |
| covering layer | | | | | | |
| Thickness of covering layer (mm) | | — | — | — | — | — |
| Tan δc (−20° C.) of covering | | — | — | — | — | — |
| layer | | | | | | |
| Storage modulus E′c (−20° C.) | | — | — | — | — | — |
| of covering layer (MPa) | | | | | | |
| Tan δc (−20° C.)/tan δout | | — | — | — | — | — |
| (−20° C.) | | | | | | |
| Tire | Durability | 100 | 100 | 100 | 105 | 105 |
| evaluation | Rolling | 100 | 100 | 95 | 100 | 100 |
| | resistance | | | | | |
| Transponder | Communication | 85 | 100 | 100 | 100 | 98 |
| evaluation | performance | | | | | |
| | Durability | Good | Poor | Good | Excellent | Excellent |

TABLE 1-2

| | | Example 3 | Example 4 | Example 5 | Example 6 | Example 7 |
|---|---|---|---|---|---|---|
| Position in tire width | | Outer side | Outer side | Outer side | Outer side | Outer side |
| direction of transponder | | | | | | |
| Position in tire radial | | D | B | A | C | C |
| direction of transponder | | | | | | |
| Tan δout (−20° C.) of outer | | 0.30 | 0.30 | 0.30 | 0.30 | 0.30 |
| member | | | | | | |
| Tan δout(0° C.)/tan δout | | 0.7 | 0.7 | 0.7 | 0.4 | 1.0 |
| (−20° C.) | | | | | | |
| Presence of covering layer | | No | No | No | No | No |
| Relative dielectric constant of | | — | — | — | — | — |
| covering layer | | | | | | |
| Thickness of covering layer (mm) | | — | — | — | — | — |
| Tan δc (−20° C.) of covering | | — | — | — | — | — |
| layer | | | | | | |
| Storage modulus E′c (−20° C.) | | — | — | — | — | — |
| of covering layer (MPa) | | | | | | |
| Tan δc (−20° C.)/tan δout | | — | — | — | — | — |
| (−20° C.) | | | | | | |
| Tire | Durability | 105 | 105 | 103 | 105 | 105 |
| evaluation | Rolling | 100 | 100 | 100 | 100 | 98 |
| | resistance | | | | | |
| Transponder | Communication | 100 | 100 | 100 | 100 | 100 |
| evaluation | performance | | | | | |
| | Durability | Excellent | Excellent | Good | Good | Excellent |

TABLE 2-1

| | | Example 8 | Example 9 | Example 10 | Example 11 | Example 12 |
|---|---|---|---|---|---|---|
| Position in tire width | | Outer side | Outer side | Outer side | Outer side | Outer side |
| direction of transponder | | | | | | |
| Position in tire radial | | C | C | C | C | C |
| direction of transponder | | | | | | |
| Tan δout (−20° C.) of outer | | 0.30 | 0.30 | 0.30 | 0.30 | 0.30 |
| member | | | | | | |
| Tan δout (0° C.)/tan δout | | 0.7 | 0.7 | 0.7 | 0.7 | 0.7 |
| (−20° C.) | | | | | | |
| Presence of covering layer | | Yes | Yes | Yes | Yes | Yes |
| Relative dielectric constant of | | 7 | 8 | 7 | 7 | 7 |
| covering layer | | | | | | |
| Thickness of covering layer (mm) | | 0.2 | 0.2 | 0.5 | 1.0 | 3.0 |
| Tan δc (−20° C.) of covering | | 0.18 | 0.18 | 0.18 | 0.18 | 0.18 |
| layer | | | | | | |
| Storage modulus E′c (−20° C.) | | 10.0 | 10.0 | 10.0 | 10.0 | 10.0 |
| of covering layer (MPa) | | | | | | |
| Tan δc (−20° C.)/tan δout | | 0.6 | 0.6 | 0.6 | 0.6 | 0.6 |
| (−20° C.) | | | | | | |
| Tire | Durability | 105 | 105 | 105 | 105 | 105 |
| evaluation | Rolling | 100 | 100 | 100 | 100 | 100 |
| | resistance | | | | | |
| Transponder | Communication | 105 | 103 | 108 | 110 | 112 |
| evaluation | performance | | | | | |
| | Durability | Excellent | Excellent | Excellent | Excellent | Excellent |

TABLE 2-2

| | | Exam- | Exam- | Exam- | Exam- |
|---|---|---|---|---|---|
| | | ple 13 | ple 14 | ple 15 | ple 16 |
| Position in tire width | | Outer | Outer | Outer | Outer |
| direction of transponder | | side | side | side | side |
| Position in tire radial | | C | C | C | C |
| direction of transponder | | | | | |
| Tan δout (−20° C.) of outer | | 0.30 | 0.30 | 0.30 | 0.30 |
| member | | | | | |
| Tan δout (0° C.)/tan δout | | 0.7 | 0.7 | 0.7 | 0.7 |
| (−20° C.) | | | | | |
| Presence of covering layer | | Yes | Yes | Yes | Yes |
| Relative dielectric constant of | | 7 | 7 | 7 | 7 |
| covering layer | | | | | |
| Thickness of covering layer (mm) | | 1.0 | 1.0 | 1.0 | 1.0 |
| Tan δc (−20° C.) of covering | | 0.18 | 0.18 | 0.06 | 0.30 |
| layer | | | | | |
| Storage modulus E′c (−20° C.) | | 2.0 | 18.0 | 10.0 | 10.0 |
| of covering layer (MPa) | | | | | |
| Tan δc (−20° C.)/tan δout | | 0.6 | 0.6 | 0.2 | 1.0 |
| (−20° C.) | | | | | |
| Tire | Durability | 105 | 105 | 105 | 105 |
| evaluation | Rolling | 100 | 100 | 100 | 100 |
| | resistance | | | | |
| Transponder | Communication | 110 | 110 | 110 | 110 |
| evaluation | performance | | | | |
| | Durability | Good | Good | Good | Good |

As can be seen from Table 1 and Table 2 here, the rolling resistance of the tire and the communication performance and durability of the transponder were improved in a well-balanced manner in the pneumatic tires of Examples 1 to 16, compared to Comparative Example 2.

On the other hand, in Comparative Example 1, the transponder was disposed on the inner side in the tire width direction of the carcass layer, and thus the communication performance of the transponder degraded. In Comparative Example 3, the tan δ of the outer member was set higher than the range specified in the first embodiment, and thus the rolling resistance of the tire degraded.

Next, tires of Comparative Examples 21 to 23 and Examples 21 to 36 were manufactured. The tires were each a pneumatic tire having a tire size of 265/40ZR20 and including: a tread portion extending in the tire circumferential direction and having an annular shape; a pair of sidewall portions disposed on both sides of the tread portion; a pair of bead portions disposed on the inner side in the tire radial direction of the sidewall portions; and a carcass layer mounted between the pair of bead portions, the pneumatic tire being embedded with a transponder. The position in the tire width direction of the transponder, the position in the tire radial direction of the transponder, the tan δin (−20° C.) of an inner member, tan δin (0° C.)/tan δin (−20° C.), the presence of a covering layer, the relative dielectric constant of the covering layer, the thickness of the covering layer, the tan δc (−20° C.) of the covering layer, the storage modulus E′c (−20° C.) of the covering layer, and tan δc (−20° C.)/tan δin (−20° C.) were set as in Table 3 and Table 4.

Comparative Examples 21 to 23 and Examples 21 to 36 used a transponder having a columnar shape, and set the distance in the tire circumferential direction from the center of the transponder to a splice portion of a tire component to 10 mm and the distance from a cross-sectional center of the transponder to a tire outer surface to 2 mm or more.

In Table 3 and Table 4, the position in the tire width direction of the transponder being “inner side” means that the transponder is disposed on the inner side in the tire width direction of the carcass layer, whereas the position in the tire width direction of the transponder being “outer side” means that the transponder is disposed on the outer side in the tire width direction of the carcass layer. Further, in Table 3 and Table 4, the position in the tire radial direction of the transponder corresponds to one of the positions A to E illustrated in FIG. 6.

In Comparative Examples 22 and 23 and Examples 21 to 36, the inner member is a bead filler. That is, in Table 3 and Table 4, “tan δin (0° C.)/tan δin (−20° C.)” is a ratio of the tan δ of the bead filler, which is the inner member. Further, “tan δc (−20° C.)/tan δin (−20° C.)” is a ratio of the tan δ of the covering layer with respect to the tan δ of the bead filler, which is the inner member. For the sake of convenience, Comparative Example 21 indicates physical properties of the bead filler as those of the inner member.

The test tires were subjected to tire evaluation (durability and rolling resistance) and transponder evaluation (communication performance and durability) in accordance with a test method described below, and the results are indicated together in Table 3 and Table 4.

### Durability (Tire and Transponder):

With each test tire mounted on a wheel of a standard rim, a travel test was performed using a drum testing machine at a temperature of −20° C., an air pressure of 120 kPa, 102% of the maximum load, and a travel speed of 81 km/h, and the distance traveled at the time of a tire failure was measured. Evaluation results are expressed as index values with Comparative Example 22 being assigned an index value of 100. Larger index values indicate superior tire durability. Further, each test tire was checked after the end of traveling for whether the transponder was communicable and whether the same was damaged. The results are indicated in three levels: “Excellent” in a case where the transponder was communicable and not damaged; “Good” in a case where the transponder was communicable but damaged; and “Poor” in a case where the transponder was not communicable.

### Rolling Resistance (Tire):

With each test tire mounted on a wheel of a standard rim, a travel test was performed using a drum testing machine at a speed of 80 km/h and a temperature of −20° C. in accordance with ISO 28580, and the rolling resistance was measured. Evaluation results are expressed as index values with Comparative Example 22 being assigned an index value of 100. Larger index values indicate lower rolling resistance and superiority.

### Communication Performance (Transponder):

For each test tire, a communication operation with the transponder was performed using a reader/writer. Specifically, the maximum communication distance was measured with the reader/writer set at a power output of 250 mW and a carrier frequency of from 860 MHz to 960 MHz. Evaluation results are expressed as index values with Comparative Example 22 being assigned an index value of 100. Larger index values indicate superior communication performance.

TABLE 3-1

| | | Comparative | Comparative | Comparative | | |
|---|---|---|---|---|---|---|
| | | Example 21 | Example 22 | Example 23 | Example 21 | Example 22 |
| Position in tire width | | Inner | Outer | Outer | Outer | Outer |
| direction of transponder | | side | side | side | side | side |
| Position in tire radial | | C | C | C | C | E |
| direction of transponder | | | | | | |
| Tan δin (−20° C.) of inner | | 0.30 | 0.05 | 0.80 | 0.30 | 0.30 |
| member | | | | | | |
| Tan δin (0° C.)/tan δin | | 0.7 | 0.7 | 0.7 | 0.7 | 0.7 |
| (−20° C.) | | | | | | |
| Presence of covering layer | | No | No | No | No | No |
| Relative dielectric constant of | | — | — | — | — | — |
| covering layer | | | | | | |
| Thickness of covering layer (mm) | | — | — | — | — | — |
| Tan δc (−20° C.) of covering | | — | — | — | — | — |
| layer | | | | | | |
| Storage modulus E′c (−20° C.) | | — | — | — | — | — |
| of covering layer (MPa) | | | | | | |
| Tan δc (−20° C.)/tan δin | | — | — | — | — | — |
| (−20° C.) | | | | | | |
| Tire | Durability | 100 | 100 | 100 | 105 | 105 |
| evaluation | Rolling | 100 | 100 | 95 | 100 | 100 |
| | resistance | | | | | |
| Transponder | Communication | 85 | 100 | 100 | 100 | 98 |
| evaluation | performance | | | | | |
| | Durability | Good | Poor | Good | Excellent | Excellent |

TABLE 3-2

| | | Example 23 | Example 24 | Example 25 | Example 26 | Example 27 |
|---|---|---|---|---|---|---|
| Position in tire width | | Outer side | Outer side | Outer side | Outer side | Outer side |
| direction of transponder | | | | | | |
| Position in tire radial | | D | B | A | C | C |
| direction of transponder | | | | | | |
| Tan δin (−20° C.) of inner | | 0.30 | 0.30 | 0.30 | 0.30 | 0.30 |
| member | | | | | | |
| Tan δin (0° C.)/tan δin | | 0.7 | 0.7 | 0.7 | 0.4 | 1.0 |
| (−20° C.) | | | | | | |
| Presence of covering layer | | No | No | No | No | No |
| Relative dielectric constant of | | — | — | — | — | — |
| covering layer | | | | | | |
| Thickness of covering layer (mm) | | — | — | — | — | — |
| Tan δc (−20° C.) of covering | | — | — | — | — | — |
| layer | | | | | | |
| Storage modulus E′c (−20° C.) | | — | — | — | — | — |
| of covering layer (MPa) | | | | | | |
| Tan δc (−20° C.)/tan δin | | — | — | — | — | — |
| (−20° C.) | | | | | | |
| Tire | Durability | 105 | 105 | 103 | 105 | 105 |
| evaluation | Rolling | 100 | 100 | 100 | 100 | 98 |
| | resistance | | | | | |
| Transponder | Communication | 100 | 100 | 100 | 100 | 100 |
| evaluation | performance | | | | | |
| | Durability | Excellent | Excellent | Good | Good | Excellent |

TABLE 4-1

| | | Example 28 | Example 29 | Example 30 | Example 31 | Example 32 |
|---|---|---|---|---|---|---|
| Position in tire width | | Outer side | Outer side | Outer side | Outer side | Outer side |
| direction of transponder | | | | | | |
| Position in tire radial | | C | C | C | C | C |
| direction of transponder | | | | | | |
| Tan δin (−20° C.) of inner | | 0.30 | 0.30 | 0.30 | 0.30 | 0.30 |
| member | | | | | | |
| Tan δin (0° C.)/tan δin | | 0.7 | 0.7 | 0.7 | 0.7 | 0.7 |
| (−20° C.) | | | | | | |
| Presence of covering layer | | Yes | Yes | Yes | Yes | Yes |
| Relative dielectric constant of | | 7 | 8 | 7 | 7 | 7 |
| covering layer | | | | | | |
| Thickness of covering layer (mm) | | 0.2 | 0.2 | 0.5 | 1.0 | 3.0 |
| Tan δc (−20° C.) of covering | | 0.24 | 0.24 | 0.24 | 0.24 | 0.24 |
| layer | | | | | | |
| Storage modulus E′c (−20° C.) | | 10.0 | 10.0 | 10.0 | 10.0 | 10.0 |
| of covering layer (MPa) | | | | | | |
| Tan δc (−20° C.)/tan δin | | 0.8 | 0.8 | 0.8 | 0.8 | 0.8 |
| (−20° C.) | | | | | | |
| Tire | Durability | 105 | 105 | 105 | 105 | 105 |
| evaluation | Rolling | 100 | 100 | 100 | 100 | 100 |
| | resistance | | | | | |
| Transponder | Communication | 105 | 103 | 108 | 110 | 112 |
| evaluation | performance | | | | | |
| | Durability | Excellent | Excellent | Excellent | Excellent | Excellent |

TABLE 4-2

| | | Exam- | Exam- | Exam- | Exam |
|---|---|---|---|---|---|
| | | ple 33 | ple 34 | ple 35 | ple 36 |
| Position in tire width | | Outer | Outer | Outer | Outer |
| direction of transponder | | side | side | side | side |
| Position in tire radial | | C | C | C | C |
| direction of transponder | | | | | |
| Tan δin (−20° C.) of inner | | 0.30 | 0.30 | 0.30 | 0.30 |
| member | | | | | |
| Tan δin (0° C.)/tan δin | | 0.7 | 0.7 | 0.7 | 0.7 |
| (−20° C.) | | | | | |
| Presence of covering layer | | Yes | Yes | Yes | Yes |
| Relative dielectric constant of | | 7 | 7 | 7 | 7 |
| covering layer | | | | | |
| Thickness of covering layer (mm) | | 1.0 | 1.0 | 1.0 | 1.0 |
| Tan δc (−20° C.) of covering | | 0.24 | 0.24 | 0.03 | 0.45 |
| layer | | | | | |
| Storage modulus E′c (−20° C.) | | 2.0 | 18.0 | 10.0 | 10.0 |
| of covering layer (MPa) | | | | | |
| Tan δc (−20° C.)/tan δin | | 0.8 | 0.8 | 0.1 | 1.5 |
| (−20° C.) | | | | | |
| Tire | Durability | 105 | 105 | 105 | 105 |
| evaluation | Rolling | 100 | 100 | 100 | 100 |
| | resistance | | | | |
| Transponder | Communication | 110 | 110 | 110 | 110 |
| evaluation | performance | | | | |
| | Durability | Good | Good | Good | Good |

As can be seen from Table 3 and Table 4 here, the rolling resistance of the tire and the communication performance and durability of the transponder were improved in a well-balanced manner in the pneumatic tires of Examples 21 to 36, compared to Comparative Example 22.

On the other hand, in Comparative Example 21, the transponder was disposed on the inner side in the tire width direction of the carcass layer, and thus the communication performance of the transponder degraded. In Comparative Example 23, the tan δ of the inner member was set higher than the range specified in the second embodiment, and thus the rolling resistance of the tire degraded.

1. A pneumatic tire, comprising:
a tread portion extending in a tire circumferential direction and having an annular shape;
a pair of sidewall portions disposed on both sides of the tread portion;
a pair of bead portions disposed on an inner side in a tire radial direction of the sidewall portions; and
a carcass layer mounted between the pair of bead portions;
the pneumatic tire being embedded with a transponder on an outer side in a tire width direction of the carcass layer; and
a tan δout (−20° C.) at −20° C. of a rubber member having a largest storage modulus at 20° C. of rubber members located on an outer side in the tire width direction of the transponder being in a range of from 0.1 to 0.7.

2. The pneumatic tire according to claim 1, wherein the tan δout (−20° C.) at −20° C. and a tan δout (0° C.) at 0° C. of the rubber member having the largest storage modulus at 20° C. of the rubber members located on the outer side in the tire width direction of the transponder satisfy a relationship 0.5≤tan δout (0° C.)/tan δout (−20° C.)≤0.95.

3. The pneumatic tire according to claim 1, wherein
the transponder is covered with a covering layer, and
a tan δc (−20° C.) at −20° C. of the covering layer and the tan δout (−20° C.) satisfy a relationship 0.3≤tan δc (−20° C.)/tan δout (−20° C.)≤0.9.

4. A pneumatic tire, comprising:
a tread portion extending in a tire circumferential direction and having an annular shape;
a pair of sidewall portions disposed on both sides of the tread portion;
a pair of bead portions disposed on an inner side in a tire radial direction of the sidewall portions; and
a carcass layer mounted between the pair of bead portions;
the pneumatic tire being embedded with a transponder on an outer side in a tire width direction of the carcass layer; and
a tan δin (−20° C.) at −20° C. of a rubber member having a largest storage modulus at 20° C. of rubber members located on an inner side in the tire width direction of the transponder being in a range of from 0.1 to 0.7.

5. The pneumatic tire according to claim 4, wherein the tan δin (−20° C.) at −20° C. and a tan δin (0° C.) at 0° C. of the rubber member having the largest storage modulus at 20° C. of the rubber members located on the inner side in the tire width direction of the transponder satisfy a relationship 0.5≤tan δin (0° C.)/tan δin (−20° C.)≤0.95.

6. The pneumatic tire according to claim 4, wherein
the transponder is covered with a covering layer, and
a tan δc (−20° C.) at −20° C. of the covering layer and the tan δin (−20° C.) satisfy a relationship 0.3≤tan δc (−20° C.)/tan δin (−20° C.)≤0.9.

7. The pneumatic tire according to claim 1, wherein
the transponder is covered with a covering layer, and
a storage modulus E′c (−20° C.) at −20° C. of the covering layer is in a range of from 3 MPa to 17 MPa.

8. The pneumatic tire according to claim 1, wherein
the transponder is covered with a covering layer, and
the covering layer has a relative dielectric constant of 7 or less.

9. The pneumatic tire according to claim 1, wherein
the transponder is covered with a covering layer, and
the covering layer is formed of a rubber or an elastomer and 20 phr or more of a white filler.

10. The pneumatic tire according to claim 9, wherein the white filler comprises from 20 phr to 55 phr of calcium carbonate.

11. The pneumatic tire according to claim 1, wherein a center of the transponder is disposed 10 mm or more away in the tire circumferential direction from a splice portion of a tire component.

12. The pneumatic tire according to claim 1, wherein the transponder is disposed between a position 15 mm away from and on an outer side in the tire radial direction of an upper end of a bead core of the bead portion and a tire maximum width position.

13. The pneumatic tire according to claim 1, wherein a distance between a cross-sectional center of the transponder and a tire outer surface is 2 mm or more.

14. The pneumatic tire according to claim 1, wherein
the transponder is covered with a covering layer, and
the covering layer has a thickness of from 0.5 mm to 3.0 mm.

15. The pneumatic tire according to claim 1, wherein
the transponder comprises an IC substrate that stores data and an antenna that transmits and receives data, and
the antenna has a helical shape.
